(19) United States
(12) Patent Application Publication
(10) Pub. No.: US 2019/0299985 A1
(43) Pub. Date: Oct. 3, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Akihiro Toda, Wako-shi (JP); Yuki Motegi, Tokyo (JP)

(21) Appl. No.: 16/286,640

(22) Filed: Feb. 27, 2019

(30) Foreign Application Priority Data
Apr. 2, 2018 (JP) 2018-070889

(51) Int. Cl. B60W 30/095; B60W 30/09; B60W 40/04

(52) U.S. Cl. CPC B60W 30/0956; B60W 2050/0075; B60W 40/04; B60W 30/09

(57) ABSTRACT

A vehicle control device includes a recognizer configured to recognize a two-wheeled vehicle dedicated lane adjacent to a subject lane on which a subject vehicle is present and a two-wheeled vehicle that is present in front of the subject vehicle, and a driving controller configured to control at least steering of the subject vehicle and cause the subject vehicle to move far away from the two-wheeled vehicle in a first case where the two-wheeled vehicle dedicated lane is not recognized and the two-wheeled vehicle is recognized by the recognizer, in comparison with a second case where the two-wheeled vehicle dedicated lane is recognized and the two-wheeled vehicle is recognized in the two-wheeled vehicle dedicated lane by the recognizer.

### CROSS-REFERENCE TO RELATED APPLICATION

This application is based upon and claims the benefit of priority from Japanese Patent Application No. 2018-070889, filed Apr. 2, 2018, the entire content of which is incorporated herein by reference.

### BACKGROUND

### Field of the Invention

The present invention relates to a vehicle control device, a vehicle control method, and a storage medium.

### Description of Related Art

In recent years, research on automatically controlling driving of a vehicle (hereinafter, referred to as automated driving) has been in progress. Meanwhile, a technique for performing control to avoid collision earlier for a higher bicycle speed by predicting a traveling direction of a bicycle on which a rider is riding is known (refer to, for example, Japanese Unexamined Patent Application, First Publication No. 2015-014948).

### SUMMARY

However, in the related art, in order to control a subject vehicle to move far away from the two-wheeled vehicle in accordance with a situation in which a two-wheeled vehicle such as a bicycle is present, there is a case where automated driving suitable for a road environment is not always able to be performed.

An aspect of the present invention has been made in consideration of such circumstances, and an object of the aspect of the present invention is to provide a vehicle control device, a vehicle control method, and a storage medium capable of performing automated driving more suitable for a road environment.

A vehicle control device, a vehicle control method, and a storage medium according to the present invention adopt the following constitutions.

According to one aspect (1) of the present invention, a vehicle control device according to an aspect of the present invention includes a recognizer configured to recognize a two-wheeled vehicle dedicated lane adjacent to a subject lane on which a subject vehicle is present and a two-wheeled vehicle that is present in front of the subject vehicle, and a driving controller configured to control at least steering of the subject vehicle and cause the subject vehicle to move far away from the two-wheeled vehicle in a first case where the two-wheeled vehicle dedicated lane is not recognized and the two-wheeled vehicle is recognized by the recognizer, in comparison with a second case where the two-wheeled vehicle dedicated lane is recognized and the two-wheeled vehicle is recognized in the two-wheeled vehicle dedicated lane by the recognizer.

According to an aspect of (2), in the vehicle control device according to the aspect of (1), in the first case, the driving controller causes the subject vehicle to move far away from the two-wheeled vehicle, and in the second case, the driving controller causes the subject vehicle not to move far away from the two-wheeled vehicle.

According to an aspect of (3), in the vehicle control device according to the aspect of (1) or (2), in the second case, the driving controller further causes the subject vehicle to move far away from the two-wheeled vehicle, in a case where a width of the two-wheeled vehicle dedicated lane is equal to or less than a predetermined width.

According to an aspect of (4), in the vehicle control device according to any one aspect of (1) to (3), the driving controller causes the subject vehicle to move far away from the two-wheeled vehicle as the width of the two-wheeled vehicle dedicated lane, which is equal to or less than the predetermined width, becomes narrower.

According to an aspect of (5), in the vehicle control device according to any one aspect of (1) to (4), in the second case, the driving controller further causes the subject vehicle to move far away from the two-wheeled vehicle based on a position related to a lane width direction of the two-wheeled vehicle recognized by the recognizer.

According to an aspect of (6), in the vehicle control device according to any one aspect of (1) to (5), in the second case, the driving controller further causes the subject vehicle to move far away from the two-wheeled vehicle, in a case where a part of a body of the two-wheeled vehicle that is present in the two-wheeled vehicle dedicated lane is included in the subject lane.

According to an aspect of (7), in the vehicle control device according to any one aspect of (1) to (6), in the first case, the driving controller further controls a speed of the subject vehicle to reduce the speed of the subject vehicle in comparison with the second case.

According to an aspect of (8), in the vehicle control device according to the aspect of (7), in the first case, the driving controller reduces the speed of the subject vehicle, and in the second case, the driving controller does not reduce the speed of the subject vehicle.

According to an aspect of (9), in the vehicle control device according to the aspect of (8), in the second case, the driving controller further reduces the speed of the subject vehicle, in a case where a width of the two-wheeled vehicle dedicated lane is equal to or smaller than a predetermined width.

According to an aspect of (10), in the vehicle control device according to the aspect of (9), the driving controller further reduces the speed of the subject vehicle as the width of the two-wheeled vehicle dedicated lane, which is equal to or less than the predetermined width, becomes narrower.

According to an aspect of (11), in the vehicle control device according to any one aspect of (7) to (10), in the second case, the driving controller further reduces the speed of the subject vehicle based on a position related to a lane width direction of the two-wheeled vehicle recognized by the recognizer.

According to an aspect of (12), in the vehicle control device according to any one aspect of (7) to (11), in the second case, the driving controller further reduces the speed of the subject vehicle in a case where a part of a body of the two-wheeled vehicle protrudes from the two-wheeled vehicle dedicated lane.

According to another aspect (13) of the present invention, a vehicle control method according to another aspect of the present invention causes an in-vehicle computer to recognize a two-wheeled vehicle dedicated lane adjacent to a subject lane on which a subject vehicle is present and a two-wheeled vehicle that is present in front of the subject vehicle, and control at least steering of the subject vehicle to cause the subject vehicle to move far away from the two-wheeled vehicle in a first case where the two-wheeled vehicle dedicated lane is not recognized and the two-wheeled vehicle is recognized, in comparison with a second case where the two-wheeled vehicle dedicated lane is recognized and the two-wheeled vehicle is recognized in the two-wheeled vehicle dedicated lane.

According to another aspect (14) of the present invention, a computer-readable non-transitory storage medium according to another aspect of the present invention stores a program that causes an in-vehicle computer to execute a process of recognizing a two-wheeled vehicle dedicated lane adjacent to a subject lane on which a subject vehicle is present and a two-wheeled vehicle that is present in front of the subject vehicle, and a process of controlling at least steering of the subject vehicle to cause the subject vehicle to move far away from the two-wheeled vehicle in a first case where the two-wheeled vehicle dedicated lane is not recognized and the two-wheeled vehicle is recognized, in comparison with a second case where the two-wheeled vehicle dedicated lane is recognized and the two-wheeled vehicle is recognized in the two-wheeled vehicle dedicated lane.

According to any one aspect of (1) to (14), it is possible to perform automated driving more suitable for a road environment.

### BRIEF DESCRIPTION OF THE DRAWINGS

FIG. 1 is a constitution diagram of a vehicle system using a vehicle control device according to a first embodiment.

FIG. 2 is a functional constitution diagram of a first controller and a second controller.

FIG. 3 is a flowchart showing an example of a flow of a series of processes by an automated driving control device according to the first embodiment.

FIG. 4 is a diagram showing an example of a scene in which a subject vehicle is automatically driven in a case where a two-wheeled vehicle travels on a road where a two-wheeled vehicle dedicated lane is not present.

FIG. 5 is a diagram showing an example of a scene in which a two-wheeled vehicle dedicated lane is recognized.

FIG. 6 is a diagram showing an example of the scene in which the two-wheeled vehicle dedicated lane is recognized.

FIG. 7 is a diagram showing an example of offset amount determination information according to the first embodiment.

FIG. 8 is a diagram showing another example of the offset amount determination information according to the first embodiment.

FIG. 9 is a diagram showing an example of a scene in which the subject vehicle M is caused to overtake the two-wheeled vehicle.

FIG. 10 is a diagram showing an example of the offset amount determination information according to a second embodiment.

FIG. 11 is a diagram showing another example of the offset amount determination information according to the second embodiment.

FIG. 12 is a diagram showing an example of a scene in which a part of a body of the two-wheeled vehicle that is present in the two-wheeled vehicle dedicated lane protrudes from the two-wheeled vehicle dedicated lane.

FIG. 13 is a diagram showing an example of speed determination information.

FIG. 14 is a diagram showing another example of the speed determination information.

FIG. 15 is a diagram showing an example of a hardware constitution of the automated driving control device according to an embodiment.

### DESCRIPTION OF EMBODIMENTS

Hereinafter, embodiments of a vehicle control device, a vehicle control method, and a storage medium of the present invention will be described with reference to the drawings. A case where left-side driving is applied to the present invention will be described below, but in a case where right-side driving is applied to the present invention, it is only necessary to reverse left and right.

### First Embodiment

[Overall Constitution]

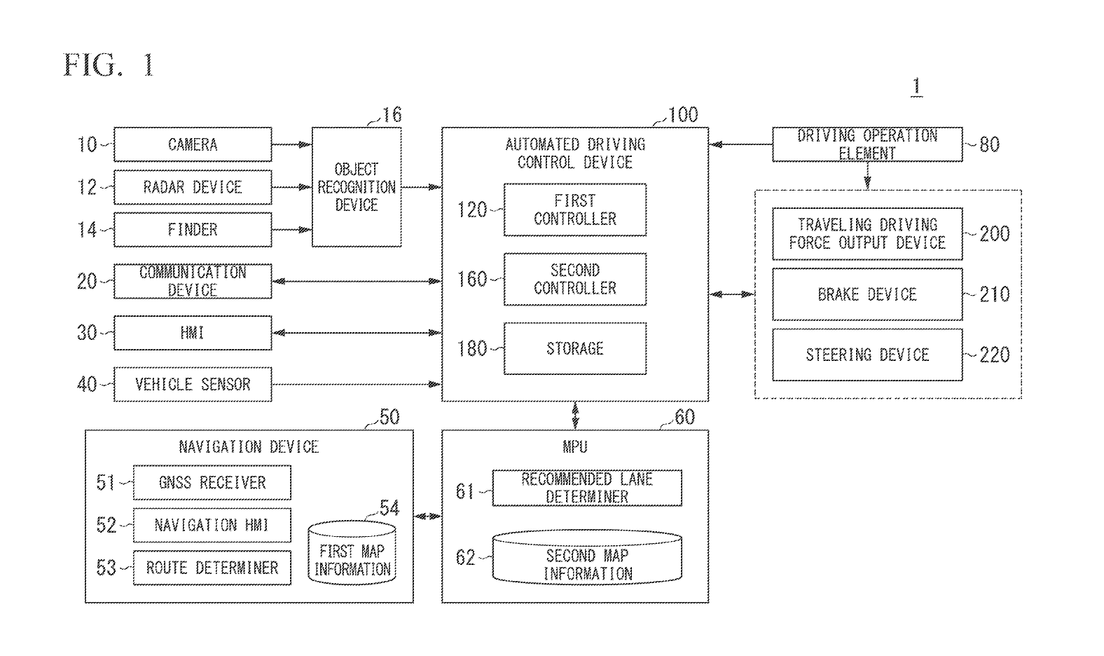

FIG. 1 is a constitution diagram of a vehicle system 1 using the vehicle control device according to a first embodiment. A vehicle (hereinafter, referred to as a subject vehicle M) in which the vehicle system 1 is mounted is, for example, a vehicle such as a two-wheeled vehicle, a three-wheeled vehicle, or a four-wheeled vehicle, and a driving source of the vehicle includes an internal combustion engine such as a diesel engine or a gasoline engine, an electric motor, or a combination thereof. The electric motor operates using electric power generated by a generator connected to the internal combustion engine, or discharge power of a secondary battery or a fuel cell.

For example, the vehicle system 1 includes a camera 10, a radar device 12, a finder 14, an object recognition device 16, a communication device 20, a human machine interface (HMI) 30, a vehicle sensor 40, a navigation device 50, a map-positioning unit (MPU) 60, a driving operation element 80, an automated driving control device 100, a traveling driving force output device 200, a brake device 210, and a steering device 220. Such devices and instruments are connected to each other by a multiplex communication line such as a controller area network (CAN) communication line, a serial communication line, a wireless communication network, or the like. The constitution shown in FIG. 1 is merely an example, and a part of the constitution may be omitted or other constitutions may be further added.

For example, the camera 10 is a digital camera using a solid imaging element such as a charge-coupled device (CCD) or a complementary metal-oxide-semiconductor (CMOS). The camera 10 is attached to an arbitrary place on the subject vehicle M. In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. The radar device 12 is attached to an arbitrary place on the subject vehicle M. The radar device 12 may detect the position and the speed of the object by a frequency-modulated continuous-wave (FM-CW) method.

The finder 14 is a light detection and ranging (LIDAR) system. The finder 14 irradiates light around the subject vehicle M and measures scattered light. The finder 14 detects the distance to the object on the basis of a time from light emission to light reception. For example, the irradiated light is laser light of a pulse shape. The finder 14 is attached to an arbitrary place on the subject vehicle M.

The object recognition device 16 performs a sensor fusion process on a detection result of some or all of the camera 10, the radar device 12, and the finder 14 to recognize a position, a type, a speed, and the like of the object. The object recognition device 16 outputs a recognition result to the automated driving control device 100. The object recognition device 16 may output the detection result of the camera 10, the radar device 12, and the finder 14 as they are to the automated driving control device 100. The object recognition device 16 may be omitted from the vehicle system 1.

For example, the communication device 20 communicates with another vehicle near the subject vehicle M using a cellular network, a Wi-Fi network, Bluetooth (registered trademark), dedicated short-range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, and the like.

The vehicle sensor 40 includes a vehicle speed sensor that detects a speed of the subject vehicle M, an acceleration sensor that detects acceleration, a yaw rate sensor that detects an angular velocity around a vertical axis, a direction sensor that detects a direction of the subject vehicle M, and the like.

For example, the navigation device 50 includes a global navigation satellite system (GNSS) receiver 51, a navigation HMI 52, and a route determiner 53. The navigation device 50 holds first map information 54 in a storage device such as a hard disk drive (HDD) or a flash memory.

The GNSS receiver 51 specifies the position of the subject vehicle M on the basis of a signal received from a GNSS satellite. The position of the subject vehicle M may be specified or supplemented by an inertial navigation system (INS) using an output of the vehicle sensor 40.

The navigation HMI 52 includes a display device, a speaker, a touch panel, a key, and the like. A part or all of the navigation HMI 52 may be shared with the above-described HMI 30.

For example, the route determiner 53 determines a route (hereinafter referred to as a route on a map) from the position of the subject vehicle M specified by the GNSS receiver 51 (or an input arbitrary position) to a destination input by the occupant using the navigation HMI 52 by referring to the first map information 54. For example, the first map information 54 is information in which a road shape is expressed by a link indicating a road and nodes connected by the link. The first map information 54 may include a curvature of the road, point of interest (POI) information, or the like. The route on the map is output to the MPU 60.

The navigation device 50 may perform route guidance using the navigation HMI 52 on the basis of the route on the map. For example, the navigation device 50 may be realized by a function of a terminal device such as a smartphone or a tablet terminal possessed by the user. The navigation device 50 may transmit a current position and a destination to a navigation server through the communication device 20 and acquire the same route as the route on the map from the navigation server.

For example, the MPU 60 includes a recommended lane determiner 61 and holds second map information 62 in the storage device such as an HDD or a flash memory. The recommended lane determiner 61 divides the route on the map provided from the navigation device 50 into a plurality of blocks (for example, divides the route into intervals of 100 [m] in a vehicle traveling direction), and determines a recommended lane for each block by referring to the second map information 62. The recommended lane determiner 61 determines the number of a lane from the left that the vehicle travels in. In a case where there is a branching position on the route on the map, the recommended lane determiner 61 determines the recommended lane so that the subject vehicle M is able to travel on a reasonable travel route for progressing to a branch destination.

The second map information 62 is map information with higher accuracy than the first map information 54. For example, the second map information 62 may include information on the center of the lane, information on the boundary of the lane, information on the type of the lane, and the like. The second map information 62 may include road information, traffic regulation information, address information (an address and a postal code), facility information, telephone number information, and the like. The second map information 62 may be updated at any time by the communication device 20 communicating with another device.

The driving operation element 80 includes, for example, an acceleration pedal, a brake pedal, a shift lever, a steering wheel, a modified steering wheel, a joystick, and other operation elements. A sensor that detects an operation amount or presence or absence of an operation is attached to the driving operation element 80, and a detection result of the sensor is output to a part or all of the automated driving control device 100, or the traveling driving force output device 200, the brake device 210, and the steering device 220.

For example, the automated driving control device 100 includes a first controller 120, a second controller 160, and a storage 180. For example, the first controller 120 and the second controller 160 are realized by a processor such as a central processing unit (CPU) or a graphics-processing unit (GPU) executing a program (software). Some or all of such constitution elements may be realized by hardware (a circuit unit including a circuitry) such as a large-scale integration (LSI), an application-specific integrated circuit (ASIC), or a field-programmable gate array (FPGA), or may be realized by software and hardware in cooperation. The program may be stored in the storage 180 of the automated driving control device 100 in advance. Alternatively, the program may be stored in a detachable storage medium such as a DVD or a CD-ROM and may be installed in the storage 180 by attachment of the storage medium thereof to a drive device.

The storage 180 is realized by, for example, a HDD, a flash memory, an electrically erasable programmable read-only memory (EEPROM), a read-only memory (ROM), a random-access memory (RAM), or the like. The storage 180 stores, for example, offset amount determination information 182 for determining an offset distance that will be described later as well as a program read and executed by the processor.

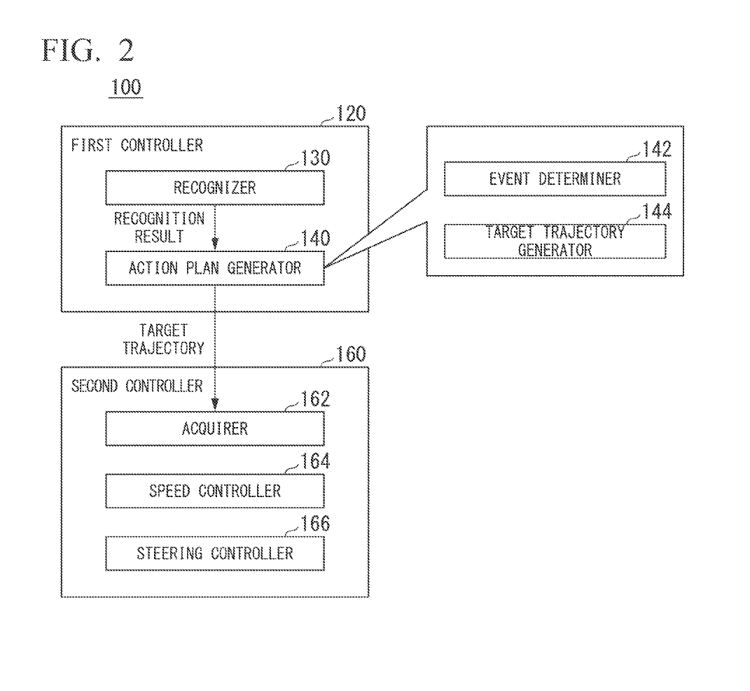

FIG. 2 is a functional constitution diagram of the first controller 120 and the second controller 160. For example, the first controller 120 includes a recognizer 130 and an action plan generator 140. For example, the first controller 120 realizes a function of artificial intelligence (AI) and a function of a previously given model in parallel. For example, a function of “recognizing an intersection” is executed in parallel with recognition of an intersection by deep learning or the like and recognition based on a previously given condition (there is a pattern-matching signal, a road sign, or the like) and may be realized by giving scores to both sides and comprehensively evaluating the scores. Therefore, reliability of automated driving is guaranteed.

The recognizer 130 recognizes an object that is present in the vicinity of the subject vehicle M on the basis of the information input from the camera 10, the radar device 12, and the finder 14 through the object recognition device 16. The object recognized by the recognizer 130 includes, for example, a bicycle, an auto-bike, a four-wheeled vehicle, a pedestrian, a road sign, a road mark, a lane marking, a utility pole, a guardrail, a falling object, and the like. The recognizer 130 recognizes a state of the object, such as a position, a speed, an acceleration, or the like. For example, the position of the object is recognized as a position on an absolute coordinate (that is, a relative position with respect to the subject vehicle M) using a representative point (center of gravity, driving axis center, or the like) of the subject vehicle M as an origin and is used for control. The position of the object may be represented by a representative point such as a center of gravity or a corner of the object, or may be represented by an expressed region. The “state” of the object may include an acceleration or jerk of the object, or “behavioral state” (for example, the object changes a lane or whether or not the object is about to change the lane).

For example, the recognizer 130 recognizes a subject lane in which the subject vehicle M is traveling and an adjacent lane that is adjacent to the subject lane. For example, the recognizer 130 recognizes the subject lane or the adjacent lane by comparing a pattern of a road lane marking (for example, an arrangement of a solid line and a broken line) obtained from the second map information 62 with a pattern of a road lane marking near the subject vehicle M recognized from the image captured by the camera 10.

The recognizer 130 may recognize the subject lane or the adjacent lane by recognizing a traveling road boundary (a road boundary) including a road lane marking, a road shoulder, a curb, a median strip, a guardrail, and the like, and is not limited to recognizing road lane markings. In this recognition, the position of the subject vehicle M acquired from the navigation device 50 or a process result by an INS may be added.

The recognizer 130 recognizes a temporary stop line, an obstacle, a red light, a toll gate, and other road events.

When recognizing the subject lane or the adjacent lane, the recognizer 130 recognizes the relative position and a posture of the subject vehicle M with respect to the subject lane. For example, the recognizer 130 may recognize an angle formed by a deviation of a reference point of the subject vehicle M from a center of the lane and a line connecting the center of the lane of a traveling direction of the subject vehicle M as a relative position and the posture of the subject vehicle M with respect to the subject lane. Instead of this, the recognizer 130 may recognize a position of the reference point of the subject vehicle M with respect to one of side end portions (the road lane marking or the road boundary) of the subject lane as the relative position of the subject vehicle M with respect to the subject lane.

The recognizer 130 may further recognize a type of the lane on the basis of the recognized road mark, the road sign, a width of the lane, or the like. For example, in a case where the recognizer 130 recognizes a road mark indicating a bicycle mark within the recognized adjacent lane, recognizes a road sign indicating a two-wheeled vehicle dedicated lane above and beside the adjacent lane, or recognizes that a road surface of the adjacent lane is colored with a predetermined color (for example, ash cherry color, brown color, blue color, or the like), the recognition recognizes the adjacent lane as a two-wheeled vehicle dedicated lane.

For example, the two-wheeled vehicle dedicated lane is a lane that is partitioned exclusively for a two-wheeled vehicle such as a bicycle, such as a bicycle dedicated traffic band or a bicycle traveling guidance band, and in principle, the two-wheeled vehicle dedicated lane is not physically partitioned by a structure such as a fence or a pole at a boundary with a roadway, and the two-wheeled vehicle dedicated lane is a lane partitioned from the roadway by a lane mark drawn on the road surface.

For example, in a case where a width of the adjacent lane is within a specified range (for example, about 0.5 [m] to 1.5 [m]), the recognizer 130 may recognize the adjacent lane as the two-wheeled vehicle dedicated lane.

The recognizer 130 may recognize that the adjacent lane is the two-wheeled vehicle dedicated lane on the basis of various kinds of information such as the type of the lane and the width of the lane included in the second map information 62.

The action plan generator 140 includes, for example, an event determiner 142 and a target trajectory generator 144. The event determiner 142 determines an automated driving event on a route on which a recommended lane is determined. The event is information that prescribes a traveling mode of the subject vehicle M.

The event includes, for example, a constant-speed traveling event in which the subject vehicle M is caused to travel on the same lane at a constant speed, a follow-up traveling event in which the subject vehicle is caused to follow the other nearby vehicle (hereinafter, referred to as a preceding vehicle) that is present within a predetermined distance (for example, within 100 [m]) in front of the subject vehicle M, a lane change event in which the subject vehicle M is caused to change the lane from the subject lane to the adjacent lane, a branch event in which the subject vehicle M is caused to branch to a target lane at a branch point of a road, a confluence event in which the subject vehicle M is caused to join to a main line at a confluence point, a takeover event for ending the automated driving and switching to the manual driving, and the like. For example, the “following” may be a traveling mode in which an inter-vehicle distance (relative distance) between the subject vehicle M and the preceding vehicle is kept constant, or may be a traveling mode in which the inter-vehicle distance between the subject vehicle M and the preceding vehicle is constant and the subject vehicle M is caused to travel at a center of the subject lane. For example, the event may include an overtaking event in which the subject vehicle M is caused to change the lane to the adjacent lane, overtake the preceding vehicle in the adjacent lane, and change the lane to an original lane again, or in which the subject vehicle M is caused to be close to a lane marking defining the subject lane without changing the lane, overtake the preceding vehicle within the same lane, and return the subject vehicle M to an original position, and an avoidance event in which the subject vehicle is caused to perform at least one of braking and steering so as to avoid an obstacle that is present in front of the subject vehicle M, and the like.

For example, the event determiner 142 may change an event that has already been determined for a current section to another event in accordance with a surrounding situation recognized by the recognizer 130 when the subject vehicle M is traveling, or may determine a new event for the current section.

In principle, the target trajectory generator 144 generates a future target trajectory that causes the subject vehicle M to travel automatically (without depending on the operation of the driver) in the traveling mode prescribed by the event, in order to cope with the surrounding situation when the subject vehicle M travels on the recommended lane determined by the recommended lane determiner 61 and the subject vehicle M further travels on the recommended lane. The target trajectory includes, for example, a position element that defines a future position of the subject vehicle M, and a speed element that defines a future speed of the subject vehicle M, and the like.

For example, the target trajectory generator 144 determines a plurality of points (trajectory points) to which the subject vehicle M should sequentially reach as the position element of the target trajectory. The trajectory point is a point to which the subject vehicle M should reach for each predetermined traveling distance (for example, about several [m]). The predetermined traveling distance may be calculated, for example, by a road distance when traveling along the route.

The target trajectory generator 144 determines a target speed and a target acceleration for each predetermined sampling time (for example, about 0 comma [sec]) as the speed element of the target trajectory. The trajectory point may be a position to which the subject vehicle M should reach at a sampling time for each predetermined sampling time. In this case, the target speed and the target acceleration are determined by the sampling time and an interval between the trajectory points. The target trajectory generator 144 outputs information indicating the generated target trajectory to the second controller 160.

The target trajectory generator 144 may change the target trajectory according to the type of the adjacent lane recognized by the recognizer 130. For example, in a case where the adjacent lane is recognized as the two-wheeled vehicle dedicated lane by the recognizer 130, the target trajectory generator 144 generates a target trajectory of which one or both of the speed element and the position element is changed as a new target trajectory corresponding to the current event.

The second controller 160 controls the traveling driving force output device 200, the brake device 210, and the steering device 220 so that the subject vehicle M passes along the target trajectory generated by the target trajectory generator 144 at a scheduled time.

For example, the second controller 160 includes an acquirer 162, a speed controller 164, and a steering controller 166. A combination of the event determiner 142, the target trajectory generator 144, and the second controller 160 is an example of a “driving controller”.

The acquirer 162 acquires information on the target trajectory (a trajectory point) generated by the target trajectory generator 144 and stores the information on the target trajectory in a memory of the storage 180.

The speed controller 164 controls one or both of the traveling driving force output device 200 and the brake device 210 on the basis of the speed element (for example, target speed, target acceleration, or the like) included in the target trajectory that is stored in the memory.

The steering controller 166 controls the steering device 220 according to the position element (for example, curvature representing a degree of curvature of the target trajectory) included in the target trajectory that is stored in the memory. Hereinafter, control of one or both of the traveling driving force output device 200, the brake device 210, and the steering device 220 will be referred to as “automated driving”.

For example, a process of the speed controller 164 and the steering controller 166 is realized by a combination of feed-forward control and feedback control. As an example, the steering controller 166 is executed by a combination of feed-forward control according to a curvature of the road ahead of the subject vehicle M and feedback control based on the deviation from the target trajectory.

The traveling driving force output device 200 outputs, to driving wheels, traveling driving force (torque) for enabling the vehicle to travel. For example, the traveling driving force output device 200 includes a combination of an internal combustion engine, an electric motor, a transmission, and the like, and a power electronic control unit (ECU) that controls the internal combustion engine, the electric motor, the transmission, and the like. The power ECU controls the above-described constitutions according to the information input from the second controller 160 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the second controller 160 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. The brake device 210 is not limited to the constitution described above, and may be an electronic control method oil pressure brake device that controls an actuator according to the information input from the second controller 160 to transfer the oil pressure of the master cylinder to the cylinder.

For example, the steering device 220 includes a steering ECU and an electric motor. For example, the electric motor changes a direction of steerable wheels by applying a force to a rack and pinion mechanism. The steering ECU changes the direction of the steerable wheels by driving the electric motor according to the information input from the second controller 160 or the information input from the driving operation element 80.

[Process Flow]

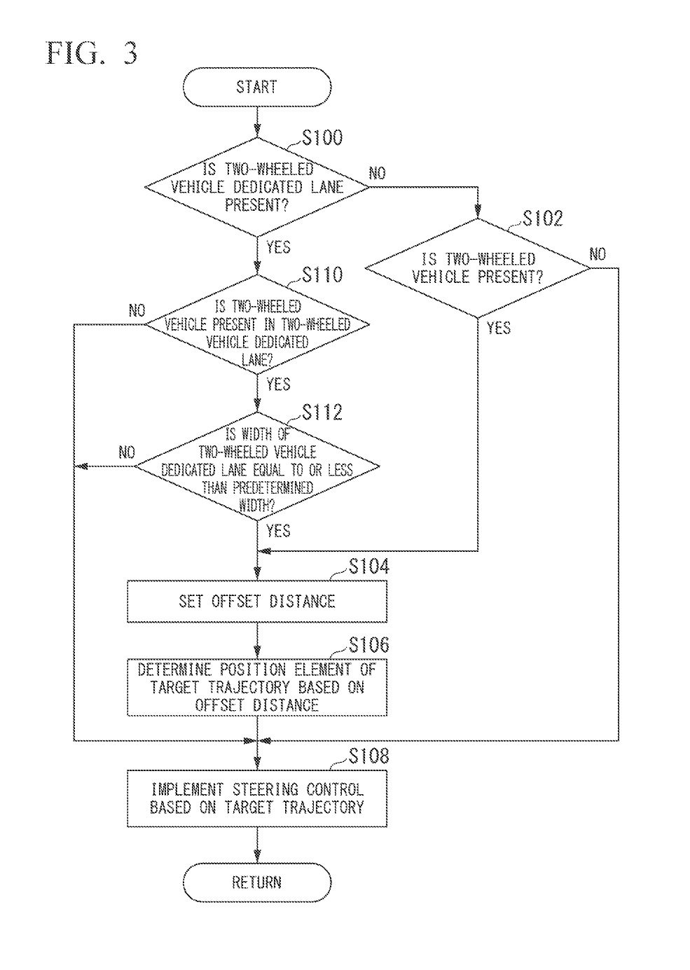

Hereinafter, a flow of a series of processes by the automated driving control device 100 of the first embodiment will be described with reference to a flowchart. FIG. 3 is a flowchart showing an example of a flow of a series of processes by the automated driving control device 100 according to the first embodiment. For example, the process of the present flowchart may be repeatedly executed at a predetermined period.

First, the recognizer 130 determines whether or not the adjacent lane is present on the basis of the recognized lane marking, and in a case where the adjacent lane is present, the recognizer 130 further determines whether or not the adjacent lane is the two-wheeled vehicle dedicated lane (step S100).

For example, the recognizer 130 determines whether or not the adjacent lane is the two-wheeled vehicle dedicated lane, on the basis of the recognized information such as the road mark in the adjacent lane, the road sign near the adjacent lane, the width of the adjacent lane, and the color of the road surface of the adjacent lane, or various kinds of information such as the type or the lane or the width of the lane included in the second map information 62.

In a case where the adjacent lane is not present or the adjacent lane is present but the adjacent lane is not the two-wheeled vehicle dedicated lane, the recognizer 130 determines whether or not the two-wheeled vehicle is present in front of the subject vehicle M and in the subject lane (step S102).

In a case where it is determined that the two-wheeled vehicle is present in front of the subject vehicle M and in the subject lane by the recognizer 130 (an example of a “first case”), the target trajectory generator 144 generates an offset distance ΔY_{OFFSET} for biasing a center position of the subject lane to a side of the lane marking far away from the two-wheeled vehicle, from two lane markings partitioning the subject lane (step S104).

Next, the target trajectory generator 144 determines the position element of the target trajectory on the basis of the determined offset distance ΔY_{OFFSET} (step S106).

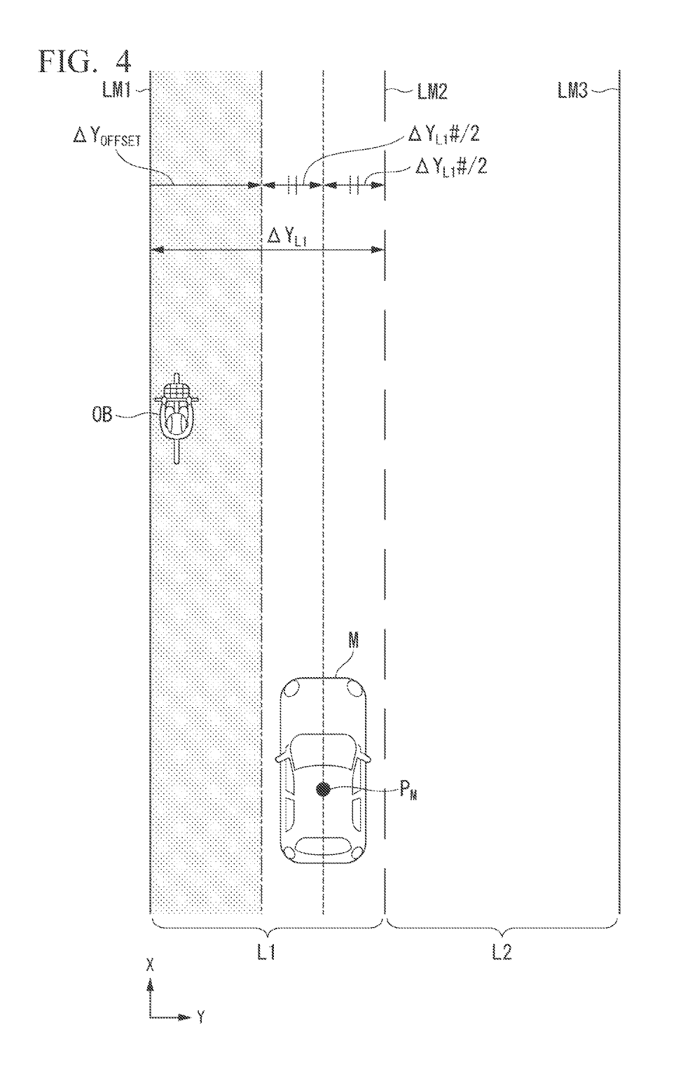

FIG. 4 is a diagram showing an example of a scene in which the subject vehicle M is automatically driven in a case where the two-wheeled vehicle travels on a road where the two-wheeled vehicle dedicated lane is not present. In the figure, X represents the traveling direction of the vehicle (an extending direction of the road), and Y represents a direction orthogonal to the X direction in the vehicle width direction. In the figure, LM1 to LM3 represent the lane markings. A region between the two lane markings LM1 and LM2 nearest to the subject vehicle M among the lane markings LM1 to LM3 is recognized as a subject lane L1 and a region between the lane markings LM2 and LM3 is recognized as one adjacent lane L2. OB in the figure represents the two-wheeled vehicle.

In the shown example, since there is no road mark indicating a mark of a bicycle on the adjacent lane L2 that is a candidate for the two-wheeled vehicle dedicated lane, a road surface is not colored with a predetermined color (the adjacent lane L2 has the same color as the subject lane L1), and the width of the adjacent lane L2 is not within a prescribed range (because the width of the adjacent lane L2 is about the same as the width of the subject lane L1), the adjacent lane L2 is not recognized as the two-wheeled vehicle dedicated lane. For example, in a case where left-hand traffic regulations apply, since the adjacent lane L2 is provided on a right side of the subject lane L1 when the adjacent lane L2 is viewed from a traveling direction of the subject vehicle M in a case where there is a law or rule that the leftmost lane of the road is used as the two-wheeled vehicle dedicated lane, the recognizer 130 may not recognize the adjacent lane L2 as the two-wheeled vehicle dedicated lane.

In a scene as the shown example, the target trajectory generator 144 determines the offset distance ΔY_{OFFSET} since the two-wheeled vehicle OB is present in a region in front viewed from the subject vehicle M in the subject lane L1 and the two-wheeled vehicle dedicated lane is not recognized. For example, the target trajectory generator 144 determines a distance for apparently shifting a center of the subject lane L1 to a side of the lane marking LM2, with reference to the lane marking LM1 closer to the two-wheeled vehicle OB, from the two lane markings partitioning the subject lane L1, as the offset distance ΔY_{OFFSET}. For example, the target trajectory generator 144 sets a predetermined distance as the offset distance ΔY_{OFFSET}. The target trajectory generator 144 determines a position that is ½ of a remaining distance ΔY_{L1}#(=ΔY_{L1}−ΔY_{OFFSET}) obtained by subtracting the determined offset distance ΔY_{OFFSET} from a width ΔY_{L1} of the subject lane L1 as a new center of the subject lane L1. In addition, the target trajectory generator 144 determines a trajectory point disposed on the new lane center as the position element of the target trajectory. As described above, in a case where the two-wheeled vehicle OB is traveling on the road where the two-wheeled vehicle dedicated lane is not present, since the target trajectory generator 144 generates the target trajectory by providing the offset distance ΔY_{OFFSET}, it is possible to cause the subject vehicle M to move far away from the two-wheeled vehicle OB than in a case where the two-wheeled vehicle dedicated lane is present and the two-wheeled vehicle OB is traveling on the two-wheeled vehicle dedicated lane, which will be described later.

Next, the second controller 160 controls the steering device 220 so that a reference P_{M} point (for example, the center of gravity) of the subject vehicle M passes along the target trajectory (a plurality of trajectory points arranged in the X direction), in accordance with the target trajectory generated by the target trajectory generator 144 (step S108). Therefore, for example, in a case where the target trajectory is generated so that a position separated from the center of the original subject lane L1 by the offset distance ΔY_{OFFSET} is set as the new lane center, the subject vehicle M travels along the center of the lane that is offset from the lane marking LM1 closer to the two-wheeled vehicle OB. In addition, in a case where an inter-vehicle distance between the subject vehicle M and the two-wheeled vehicle OB in the rear of the subject vehicle M becomes equal to or greater than a predetermined distance after overtaking (after passing) the two-wheeled vehicle OB, the target trajectory generator 144 may generate a target trajectory including a trajectory point disposed on the center of the original subject lane, which is not offset, as the position element.

On the other hand, in the process of S102, in a case where it is determined that the two-wheeled vehicle is not present in front of the subject vehicle M and in the subject lane by the recognizer 130, for example, the target trajectory generator 144 generates the target trajectory including the trajectory point disposed on the center of the original subject lane, which is not offset, as the position element, in a case where the current event is a constant-speed traveling event or a follow-up traveling event. That is, the target trajectory generator 144 generates the target trajectory with the offset distance ΔY_{OFFSET} as zero. In a case where such a trajectory is generated, the second controller 160 causes the subject vehicle M to travel at a position that is ½ of ΔY_{L1}.

On the other hand, in the process of S100, in a case where the adjacent lane is present and the adjacent lane is the two-wheeled vehicle dedicated lane, the recognizer 130 determines whether or not the two-wheeled vehicle is present in front of the subject vehicle M and in the two-wheeled vehicle dedicated lane (step S110).

In a case where it is determined that the two-wheeled vehicle is not present in front of the subject vehicle M and in the two-wheeled vehicle dedicated lane by the recognizer 130, for example, the target trajectory generator 144 generates the target trajectory including the trajectory point disposed on the center of the original subject lane, which is not offset, as the position element, in a case where the current event is a constant-speed traveling event or a follow-up traveling event. In addition, as the process of S108, the second controller 160 causes the subject vehicle M to travel at a position that is ½ of ΔY_{L1}.

On the other hand, in a case where the recognizer 130 determines that the two-wheeled vehicle is present in front of the subject vehicle M and in the two-wheeled vehicle dedicated lane (an example of a “second case”), the recognizer 130 determines whether or not the recognized width of the two-wheeled vehicle dedicated lane is equal to or less than the predetermined width ΔY_{TH1} (step S112).

In a case where it is determined that the width of the two-wheeled vehicle dedicated lane is equal to or less than the predetermined width ΔY_{TH1} by the recognizer 130, the target trajectory generator 144 advances the process to S104, determines the offset distance ΔY_{OFFSET}, and determines the position element of the target trajectory on the basis of the determined offset distance ΔY_{OFFSET} as the process of S106. On the other hand, in a case where it is determined that the width of the two-wheeled vehicle dedicated lane is greater than the predetermined width ΔY_{TH1} by the recognizer 130, the target trajectory generator 144 generates the target trajectory including the trajectory point disposed on the center of the subject lane as the position element.

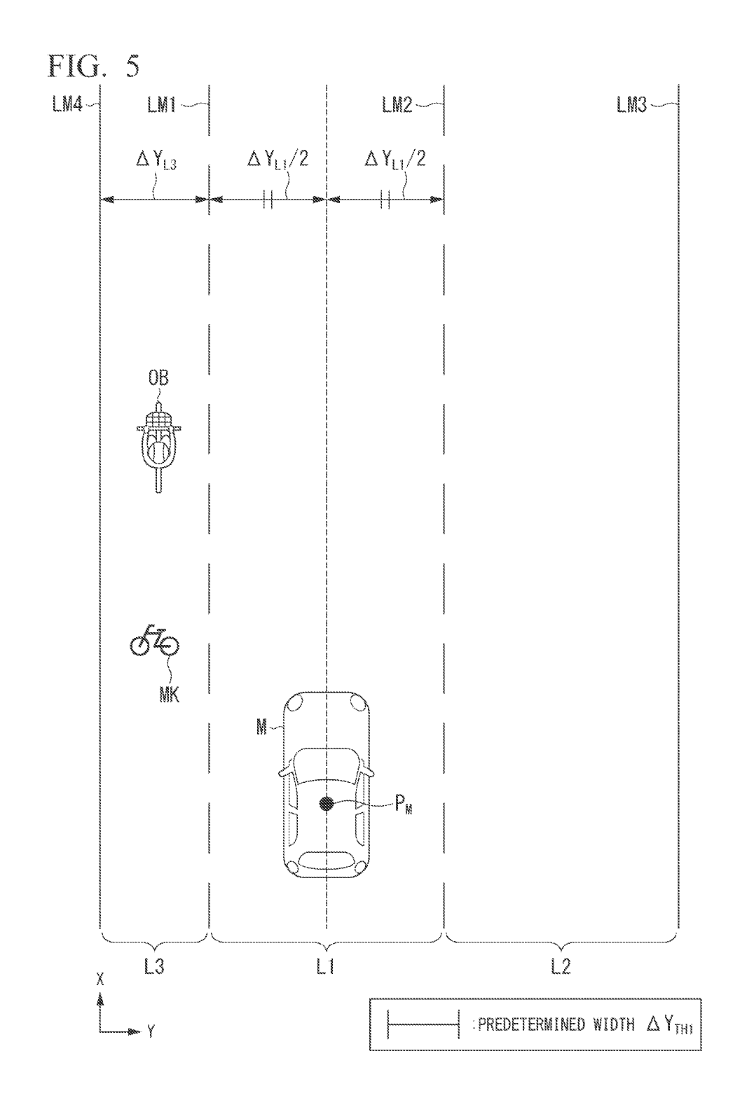

FIGS. 5 and 6 are diagrams showing an example of a scene in which a two-wheeled vehicle dedicated lane is recognized. LM1 to LM4 in the figure represent the lane markings. A region between the two lane markings LM1 and LM2 nearest to the subject vehicle M among the lane markings LM1 to LM4 is recognized as a subject lane L1, a region between the lane markings LM2 and LM3 is recognized as one adjacent lane L2, and a region between the lane markings LM1 and LM4 is recognized as another adjacent lane L3. A road mark MK representing a mark of the bicycle is formed on the adjacent lane L3.

In this case, since the road mark MK representing the mark of the bicycle is formed on the adjacent lane L3, the recognizer 130 determines that the recognized adjacent lane L3 is the two-wheeled vehicle dedicated lane. Since the two-wheeled vehicle OB is present in the adjacent lane L3 recognized as the two-wheeled vehicle dedicated lane, the recognizer 130 determines whether or not the width ΔY_{L3} of the adjacent lane L3 is equal to or less than the predetermined width ΔY_{TH1}.

In the example of FIG. 5, the width ΔY_{L3} of the two-wheeled vehicle dedicated lane L3 is greater than the predetermined width ΔY_{TH1}. In such a case, the target trajectory generator 144 generates the target trajectory including the trajectory point disposed on the center (the position where ΔY_{L1} is ½) of the original subject lane L1, which is not offset, as the position element. In response to this, the second controller 160 controls the steering device 220 so that the reference point P_{M} of the subject vehicle M passes through the position that is ½ of ΔY_{L1}.

On the other hand, in the example of FIG. 6, the width ΔY_{L3} of the two-wheeled vehicle dedicated lane L3 is equal to or less than the predetermined width ΔY_{TH1}. In such a case, the target trajectory generator 144 determines the distance for apparently shifting the center of the subject lane L1 to the side of the lane marking LM2, with reference to the lane marking LM1 on a side of the two-wheeled vehicle dedicated lane L3, from the two lane markings partitioning the subject lane L1, as the offset distance ΔY_{OFFSET}. For example, the target trajectory generator 144 determines the distance as the offset distance ΔY_{OFFSET} on the basis of the width ΔY_{L3} of the two-wheeled vehicle dedicated lane L3 and the offset amount determination information 182 stored in the storage 180. In a case where the inter-vehicle distance between the subject vehicle M and the two-wheeled vehicle OB in the rear of the subject vehicle M becomes equal to or greater than a predetermined distance after overtaking the two-wheeled vehicle OB, the target trajectory generator 144 generates the target trajectory including the trajectory point disposed on the center of the original subject lane, which is not offset, as the position element. Therefore, it is possible to cause the subject vehicle M to overtake the two-wheeled vehicle OB at a position sufficiently far away from the two-wheeled vehicle OB.

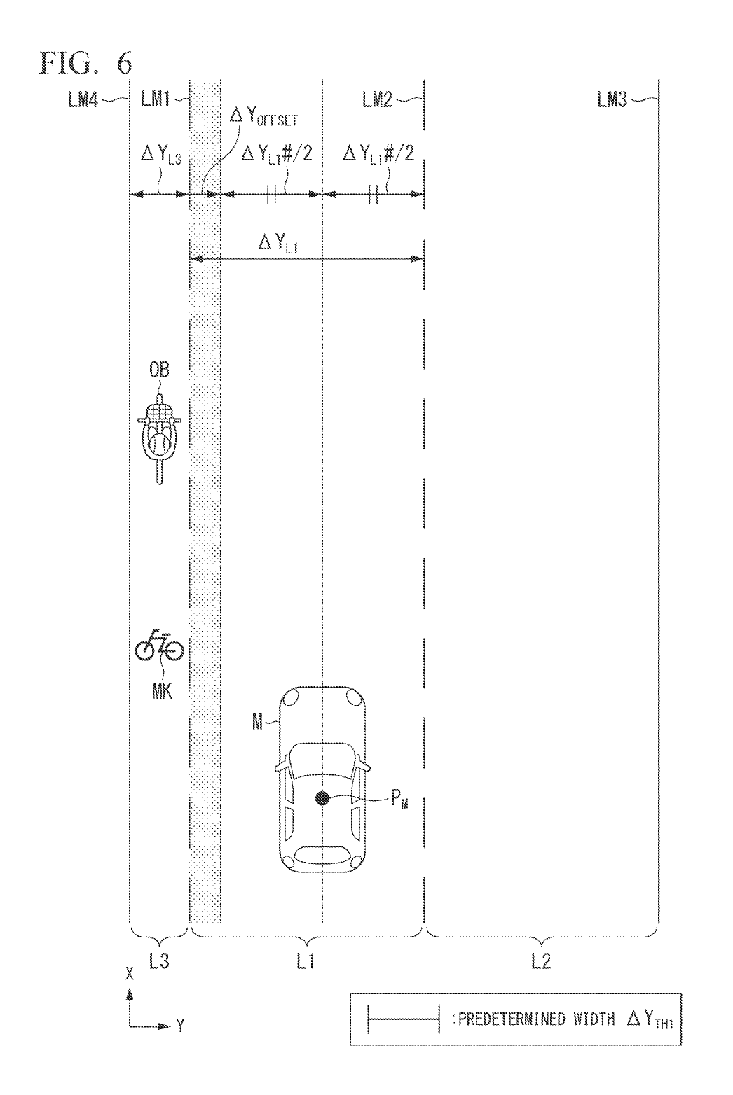

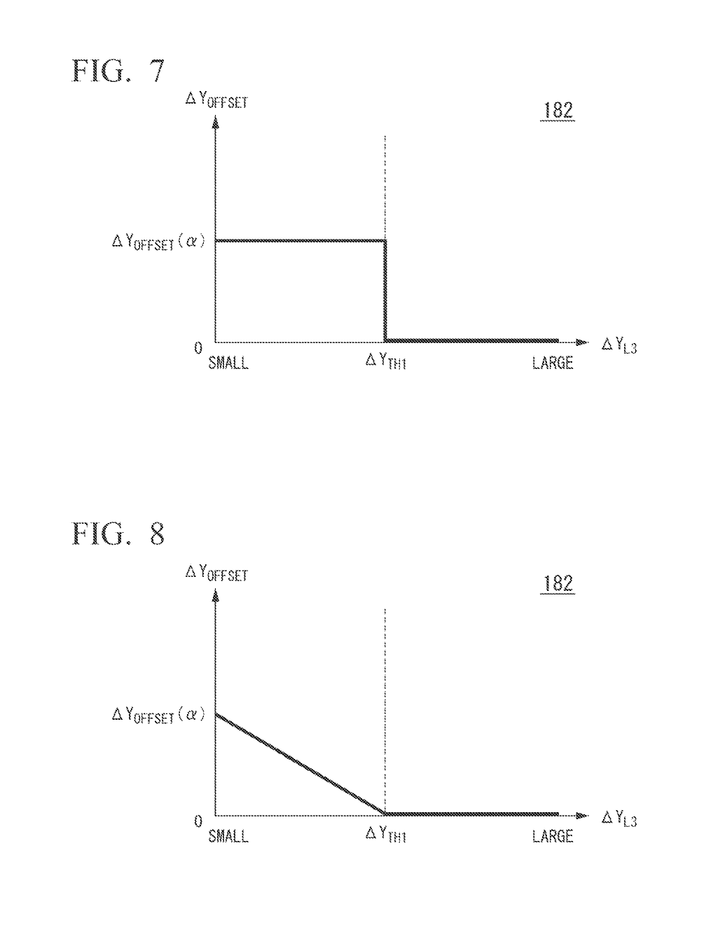

FIG. 7 is a diagram showing an example of the offset amount determination information 182 according to the first embodiment. For example, the offset amount determination information 182 is information in which a magnitude of the offset distance ΔY_{OFFSET} is associated with a magnitude of the width ΔY_{L3} of the two-wheeled vehicle dedicated lane L3. In the offset amount determination information 182, for example, a distance of zero is associated with a width ΔY_{L3} that is a width ΔY_{L3} greater than the predetermined width ΔY_{TH1}, and a certain first offset distance ΔY_{OFFSET}(α) is associated with a width ΔY_{L3} that is a width ΔY_{L3} equal to or less than the predetermined width ΔY_{TH1}. Therefore, in a case where the two-wheeled vehicle OB is present on the two-wheeled vehicle dedicated lane L3 and the width ΔY_{L3} of the two-wheeled vehicle dedicated lane L3 is greater than the predetermined width ΔY_{TH1}, the offset distance ΔY_{OFFSET} is determined as a zero distance, and in a case where the width ΔY_{L3} of the two-wheeled vehicle dedicated lane L3 is equal to or less than the predetermined width ΔY_{TH1}, the offset distance ΔY_{OFFSET} is determined as the first offset distance ΔY_{OFFSET}(α).

In the example described above, the target trajectory generator 144 determines the offset distance ΔY_{OFFSET} as one of two values of the zero distance or the first offset distance ΔY_{OFFSET}(α) with reference to the predetermined width ΔY_{TH1}, but the present invention is not limited thereto. For example, the target trajectory generator 144 may increase the offset distance ΔY_{OFFSET} as the width ΔY_{L3} of the two-wheeled vehicle dedicated lane L3 having the predetermined width ΔY_{TH1} becomes narrower, with reference to the offset amount determination information 182.

FIG. 8 is a diagram showing another example of the offset amount determination information 182 according to the first embodiment. For example, the offset amount determination information 182 may be information in which a larger offset distance ΔY_{OFFSET} is associated with the width ΔY_{L3} of the two-wheeled vehicle dedicated lane L3 as the width ΔY_{L3} of the two-wheeled vehicle dedicated lane L3 becomes narrower, with the first offset distance ΔY_{OFFSET}(α) as an upper limit of the offset distance ΔY_{OFFSET} and the zero distance as a lower limit of the offset distance ΔY_{OFFSET}, in a range in which the width ΔY_{L3} of the two-wheeled vehicle dedicated lane L3 is equal to or less than the predetermined width ΔY_{TH1}. In the shown example, the offset distance ΔY_{OFFSET} linearly changes according to an increase or decrease of the width Δ_{L3} of the two-wheeled vehicle dedicated lane L3, but the present invention is not limited thereto, and the offset distance ΔY_{OFFSET} may change in a non-linear manner, such as according to a quadratic function or an exponential function.

According to the first embodiment described above, the recognizer 130 that recognizes the two-wheeled vehicle dedicated lane that is present adjacent to the subject lane on which the subject vehicle M is present and the two-wheeled vehicle OB that is present in front of the subject vehicle M, the target trajectory generator 144 that generates the target trajectory by increasing the offset distance ΔY_{OFFSET} in comparison with a case where the two-wheeled vehicle dedicated lane is recognized and the two-wheeled vehicle OB is recognized in the two-wheeled vehicle dedicated lane by the recognizer 130, in a case where two-wheeled vehicle dedicated lane is not recognized and the two-wheeled vehicle OB is recognized by the recognizer 130, and the second controller 160 that controls at least the steering device 220 on the basis of the target trajectory generated by the target trajectory generator 144 are provided. Therefore, in a case where the two-wheeled vehicle OB is traveling in front of the subject vehicle M in a state in which the two-wheeled vehicle dedicated lane is not present, the subject vehicle M is caused to pass a side of the two-wheeled vehicle OB after causing the subject vehicle M to move far away from the two-wheeled vehicle OB by a fixed distance or more. In a case where the two-wheeled vehicle OB is traveling in the two-wheeled vehicle dedicated lane in a state in which the two-wheeled vehicle dedicated lane is present, since a probability that the two-wheeled vehicle OB protrudes from the two-wheeled vehicle dedicated lane is low. Therefore, when passing the side of the two-wheeled vehicle OB, the subject vehicle M is not caused to move far away from the two-wheeled vehicle OB in comparison with a case where the two-wheeled vehicle dedicated lane is not present. As described above, since an extent of the distance by which the subject vehicle M is caused to move away from the two-wheeled vehicle OB is determined according to whether the two-wheeled vehicle OB is traveling in the two-wheeled vehicle dedicated lane or another road region, it is possible to perform automated driving more suitable for a road environment.

### Second Embodiment

Hereinafter, a second embodiment will be described. The second embodiment is different from the above-described first embodiment in that in a case where the two-wheeled vehicle dedicated lane is recognized and the two-wheeled vehicle OB is recognized in the two-wheeled vehicle dedicated lane by the recognizer 130, the subject vehicle M is caused to overtake the two-wheeled vehicle OB by causing the subject vehicle M to move away from the two-wheeled vehicle OB, on the basis of a position related to the lane width direction (Y direction) (hereinafter, referred to as a lateral position) of the two-wheeled vehicle OB. Hereinafter, differences from the first embodiment will be mainly described, and descriptions of functions and the like which are the same as in the first embodiment will be omitted.

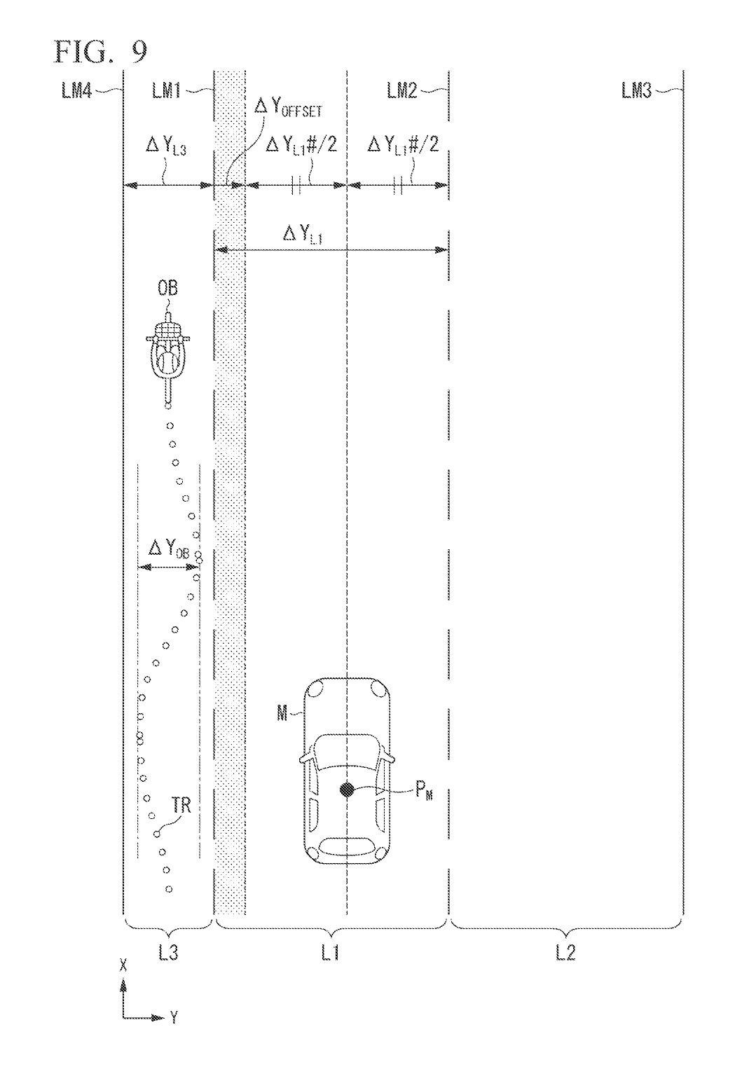

FIG. 9 is a diagram showing an example of a scene in which the subject vehicle M is caused to overtake the two-wheeled vehicle OB. For example, in a case where the two-wheeled vehicle dedicated lane L3 is recognized and the two-wheeled vehicle OB is recognized in the two-wheeled vehicle dedicated lane L3 by the recognizer 130, the event determiner 142 according to the second embodiment determines whether or not a maximum ΔY_{OB} of a variation amount of the lateral position of the two-wheeled vehicle OB in a predetermined time or a maximum ΔY_{OB} of a variation amount of the lateral position of the two-wheeled vehicle OB in a predetermined distance is equal to or greater than a threshold value. In a case where the maximum ΔY_{OB} of the variation amount of the lateral position is equal to or greater than the threshold value, since a probability that the two-wheeled vehicle OB is wandering in the two-wheeled vehicle dedicated lane L3 is high and it is difficult to predict a future behavior of the two-wheeled vehicle OB, in order to cause the subject vehicle M to overtake the wandering two-wheeled vehicle OB, the current event is changed to the overtaking event.

In a case where it is determined that the maximum ΔY_{OB} of the variation amount of the lateral position of the two-wheeled vehicle OB is equal to or larger than the threshold value and the current event is changed to the overtaking event by the event determiner 142, the target trajectory generator 144 according to the second embodiment determines the offset distance ΔY_{OFFSET} with reference to the offset amount determination information 182 and generates a target trajectory for causing the subject vehicle M to overtake the two-wheeled vehicle OB.

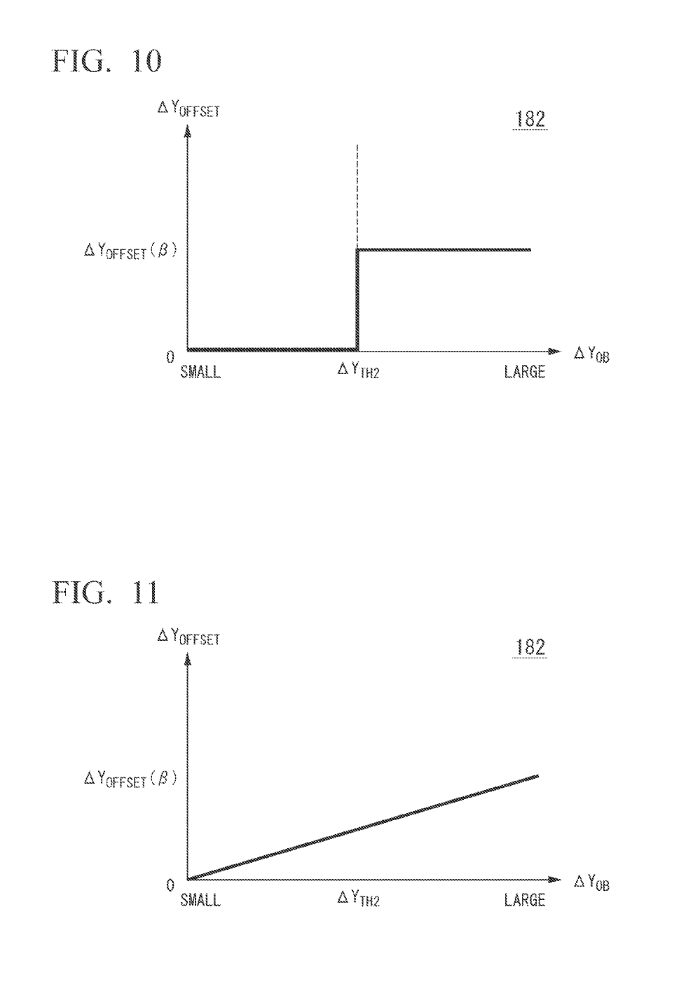

FIG. 10 is a diagram showing an example of the offset amount determination information 182 according to the second embodiment. For example, the offset amount determination information 182 is information in which a magnitude of the offset distance ΔY_{OFFSET} is associated with a magnitude of the maximum ΔY_{OB} of the variation amount of the lateral position of the two-wheeled vehicle OB. In the offset amount determination information 182, for example, a distance of zero is associated with a width ΔY_{L3} in a maximum ΔY_{OB} of a variation amount less than a threshold value ΔY_{TH2}, and a certain second offset distance ΔY_{OFFSET}(β) is associated with a width ΔY_{L3} in a maximum ΔY_{OB} of a variation amount equal to or greater than the threshold value ΔY_{TH2}. The second offset distance ΔY_{OFFSET}(β) may be the same distance as the first offset distance ΔY_{OFFSET}(α), or may be a distance different from the first offset distance ΔY_{OFFSET}(α). Therefore, in a case where the two-wheeled vehicle OB is present in the two-wheeled vehicle dedicated lane L3 and the maximum ΔY_{OB} of the variation amount of the lateral position of the two-wheeled vehicle OB is less than the threshold ΔY_{TH2}, the offset distance ΔY_{OFFSET} is determined as the zero distance, and in a case where the maximum ΔY_{OB} of the variation amount of the lateral position of the two-wheeled vehicle OB is equal to or greater than the threshold ΔY_{TH2}, the offset distance ΔY_{OFFSET} is determined as the second offset distance ΔY_{OFFSET}(β).

In the example described above, the target trajectory generator 144 determines the offset distance ΔY_{OFFSET} as one of two values of the zero distance or the second offset distance ΔY_{OFFSET}(β) with reference to the threshold ΔY_{TH2}, but the present invention is not limited thereto. For example, the target trajectory generator 144 may increase the offset distance ΔY_{OFFSET} as the maximum ΔY_{OB} of the variation amount of the lateral position of the two-wheeled vehicle OB increases, with reference to the offset amount determination information 182.

FIG. 11 is a diagram showing another example of the offset amount determination information 182 according to the second embodiment. For example, the offset amount determination information 182 may be information in which a larger offset distance ΔY_{OFFSET} is associated with the width ΔY_{L3} of the two-wheeled vehicle dedicated lane L3 as the maximum ΔY_{OB} of the variation amount of the lateral position of the two-wheeled vehicle OB increases, with the second offset distance ΔY_{OFFSET}(β) as an upper limit of the offset distance ΔY_{OFFSET} and the zero distance as a lower limit of the offset distance ΔY_{OFFSET}. In the shown example, the offset distance ΔY_{OFFSET} linearly changes according to an increase or decrease of the maximum ΔY_{OB} of the variation amount of the lateral position of the two-wheeled vehicle OB, but the present invention is not limited thereto, and the offset distance ΔY_{OFFSET} may change in a non-linear manner, such as a quadratic function or an exponential function.

In a case where the target trajectory generator 144 determines the offset distance ΔY_{OFFSET} on the basis of the offset amount determination information 182 and the maximum ΔY_{OB} of the variation amount of the lateral position of the two-wheeled vehicle OB, the target trajectory generator 144 generates a target trajectory for causing the subject vehicle M to overtake the two-wheeled vehicle OB in response to the change of the current event to the overtaking event by the event determiner 142. For example, as illustrated in FIG. 9, the target trajectory generator 144 generates a target trajectory including a trajectory point disposed on a position that is ½ of a remaining distance ΔY_{L1}# obtained by subtracting the determined offset distance ΔY_{OFFSET} from the width ΔY_{L1} of the subject lane L1 as the position element of the target trajectory. Therefore, the subject vehicle M overtakes the two-wheeled vehicle OB in the subject lane L1.

The target trajectory generator 144 may generate a target trajectory for causing the subject vehicle M to change the lane to the adjacent lane L2 (the adjacent lane that is not the two-wheeled vehicle dedicated lane L3) and causing the subject vehicle M to change the lane on the original lane L1, after setting an inter-vehicle distance that is equal to or greater than a predetermined distance since the subject vehicle M overtakes the two-wheeled vehicle OB on the adjacent lane L2.

In the second embodiment described above, the event determiner 142 determines whether or not the maximum ΔY_{OB} of the variation amount of the lateral position of the two-wheeled vehicle OB in the predetermined time or the maximum ΔY_{OB} of the variation amount of the lateral position of the two-wheeled vehicle OB in the predetermined distance is equal to or greater than the threshold value to determine whether or not to change the current event to the overtaking event, but the present invention is not limited thereto. For example, the event determiner 142 may determine whether or not an average of the variation amount of the lateral position of the two-wheeled vehicle OB in the predetermined time or an average of the variation amount of the lateral position of the two-wheeled vehicle OB in the predetermined distance is equal to or greater than a threshold value, and in a case where the average of the variation amount of the lateral position is equal to or larger than the threshold value, the event determiner 142 may change the current event to the overtaking event. The event determiner 142 may count the number of times that the variation amount of the lateral position of the two-wheeled vehicle OB is greater than a threshold value while a predetermined time has elapsed or the two-wheeled vehicle OB proceeds by a predetermined distance, and in a case where the counted number of times is equal to or greater than a predetermined number of times, the event determiner 142 may change the current event to the overtaking event.

The target trajectory generator 144 according to the second embodiment described above may determine the offset distance ΔY_{OFFSET} on the basis of the average of the variation amount of the lateral position of the two-wheeled vehicle OB or the number of times that the variation amount of the lateral position of the two-wheeled vehicle OB is greater than the threshold value, in addition to or instead of the maximum ΔY_{OB} of the variation amount of the lateral position of the two-wheeled vehicle OB, and may generate the target trajectory causing the subject vehicle M to overtake the two-wheeled vehicle OB.

According to the second embodiment described above, in a case where the two-wheeled vehicle dedicated lane is recognized and the two-wheeled vehicle OB is recognized in the two-wheeled vehicle dedicated lane by the recognizer 130, in order to cause the subject vehicle M to overtake the two-wheeled vehicle OB by causing the subject vehicle M to move far away from the two-wheeled vehicle OB, on the further basis of the lateral position of the two-wheeled vehicle OB, it is possible to cause the subject vehicle M to overtake the two-wheeled vehicle OB in a state in which the subject vehicle M is sufficiently far away from the two-wheeled vehicle OB of the adjacent lane. As a result, it is possible to perform automated driving more suitable for a road environment.

### Third Embodiment

Hereinafter, a third embodiment will be described. The third embodiment is different from the first and the second embodiments in that in a case where the two-wheeled vehicle dedicated lane is recognized and the two-wheeled vehicle OB is recognized in the two-wheeled vehicle dedicated lane by the recognizer 130, the subject vehicle M is caused to overtake the two-wheeled vehicle OB by causing the subject vehicle M to move far away from the two-wheeled vehicle OB, in a case where a part of a body of the two-wheeled vehicle OB that is present in the two-wheeled vehicle dedicated lane protrudes from the two-wheeled vehicle dedicated lane. For example, the protrusion from the two-wheeled vehicle dedicated lane includes a situation in which a part of the body of the two-wheeled vehicle OB that is present in the two-wheeled vehicle dedicated lane overlaps with the subject lane when seen from above. Hereinafter, differences from the first and second embodiments will be mainly described, and description of functions and the like which are the same as in the first and second embodiments will be omitted.

For example, in a case where it is recognized that the two-wheeled vehicle dedicated lane L3 is recognized and the two-wheeled vehicle OB is recognized in the two-wheeled vehicle dedicated lane L3 by the recognizer 130, the event determiner 142 according to the third embodiment determines whether or not a part of the body of the two-wheeled vehicle OB that is present in the two-wheeled vehicle dedicated lane protrudes from the two-wheeled vehicle dedicated lane, and in a case where the part of the body of the two-wheeled vehicle OB protrudes from the two-wheeled vehicle dedicated lane, the event determiner 142 changes the current event to the overtaking event.

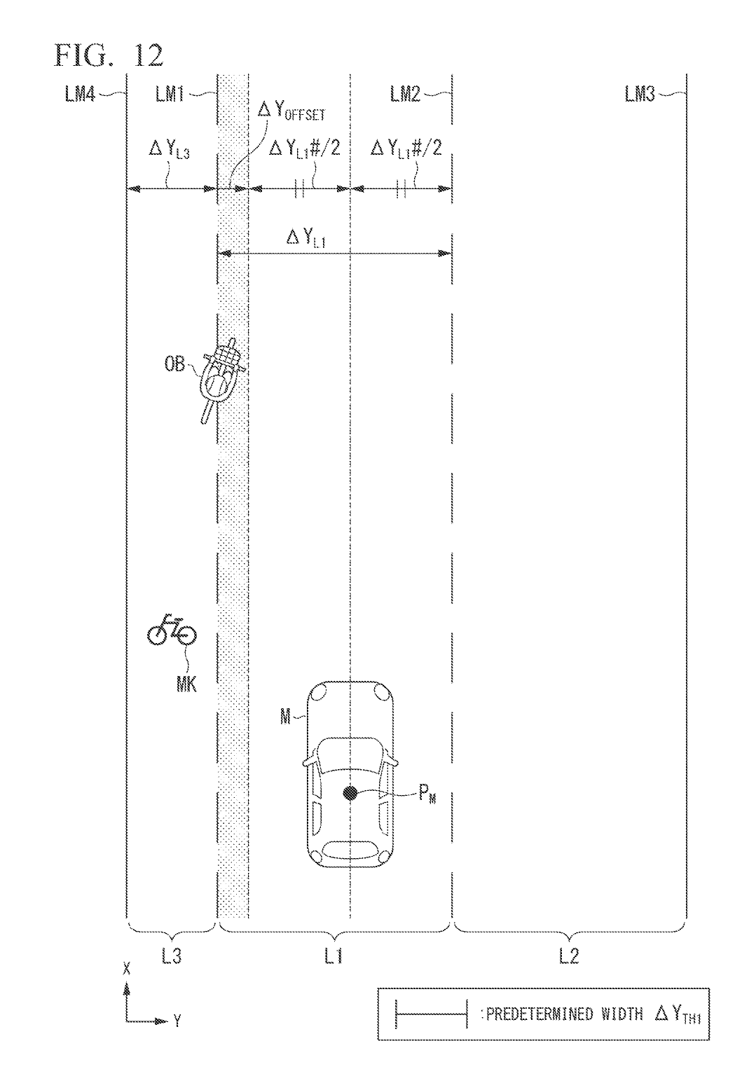

FIG. 12 is a diagram showing an example of a scene in which a part of the body of the two-wheeled vehicle OB that is present in the two-wheeled vehicle dedicated lane protrudes from the two-wheeled vehicle dedicated lane. In the shown example, since the width ΔY_{L3} of the two-wheeled vehicle dedicated lane L3 is greater than the predetermined width ΔY_{LH1}, originally, the target trajectory generator 144 generates the target trajectory including the target point disposed on the center (the position where the ΔY_{L1} is ½) of the original subject lane L1, which is not offset, as the position element, similarly to the scene shown exemplified in FIG. 5. However, in the scene exemplified in FIG. 12, since the part of the body of the two-wheeled vehicle OB protrudes from the two-wheeled vehicle dedicated lane L3, the event determiner 142 changes the current event to the overtaking event. In response to this, similarly to the second embodiment, the target trajectory generator 144 determines the offset distance ΔY_{OFFSET} with reference to the offset amount determination information 182, and generates the target trajectory for causing the subject vehicle M to overtake the two-wheeled vehicle OB.

For example, the target trajectory generator 144 generates a target trajectory including a trajectory point disposed on a position that is ½ of a remaining distance ΔY_{L1}# obtained by subtracting the determined offset distance ΔY_{OFFSET} from the width ΔY_{L1} of the subject lane L1 as the position element of the target trajectory. Therefore, the subject vehicle M overtakes the two-wheeled vehicle OB in the subject lane L1. The target trajectory generator 144 may generate a target trajectory for causing the subject vehicle M to change the lane to the adjacent lane L2 (the adjacent lane that is not the two-wheeled vehicle dedicated lane L3) and causing the subject vehicle M to change the lane on the original lane L1, after setting an inter-vehicle distance that is equal to or greater than a predetermined distance since the subject vehicle M overtakes the two-wheeled vehicle OB on the adjacent lane L2.

According to the third embodiment described above, in a case where the two-wheeled vehicle dedicated lane is recognized and the two-wheeled vehicle OB is recognized in the two-wheeled vehicle dedicated lane by the recognizer 130, in order to cause the subject vehicle M to overtake the two-wheeled vehicle OB by causing the subject vehicle M to move far away from the two-wheeled vehicle OB, further in a case where a part of the body of the two-wheeled vehicle OB that is present in the two-wheeled vehicle dedicated lane protrudes from the two-wheeled vehicle dedicated lane, it is possible to cause the subject vehicle M to overtake the two-wheeled vehicle OB in a state in which the subject vehicle M is sufficiently far away from the two-wheeled vehicle OB of the adjacent lane. As a result, it is possible to perform automated driving more suitable for a road environment.

### Fourth Embodiment

Hereinafter, a fourth embodiment will be described. In the first to third embodiments described above, in a case where the two-wheeled vehicle dedicated lane is not recognized and the two-wheeled vehicle OB is recognized by the recognizer 130, the subject vehicle M is caused to move far away from the two-wheeled vehicle OB in comparison with a case where the two-wheeled vehicle dedicated lane is recognized and the two-wheeled vehicle OB is recognized in the two-wheeled vehicle dedicated lane by the recognizer 130, in a case where the two-wheeled vehicle dedicated lane is recognized and the two-wheeled vehicle OB is recognized in the two-wheeled vehicle dedicated lane by the recognizer 130, and further in a case where the variation amount of the lateral position of the two-wheeled vehicle OB is large, the subject vehicle M is caused to move far away from the two-wheeled vehicle OB, or in a case where the two-wheeled vehicle dedicated lane is recognized and the two-wheeled vehicle OB is recognized in the two-wheeled vehicle dedicated lane by the recognizer 130, and further in a case where a part of the body of the two-wheeled vehicle OB that is present in the two-wheeled vehicle dedicated lane protrudes from the two-wheeled vehicle dedicated lane, the subject vehicle M is caused to move far away from the two-wheeled vehicle OB.

On the other hand, the fourth embodiment is different from the first to third embodiments described above in that the speed of the subject vehicle M is changed, in a case where the above-described various conditions are satisfied, in addition to or instead of causing the subject vehicle M to move far away from the two-wheeled vehicle OB. Hereinafter, differences from the first to third embodiments will be mainly described, and descriptions of the functions and the like which are the same as in the first to third embodiments will be omitted.

For example, in a case where it is recognized that the two-wheeled vehicle dedicated lane is not recognized and the two-wheeled vehicle OB is recognized by the recognizer 130, the target trajectory generator 144 according to the fourth embodiment determines the speed element of the target trajectory, on the basis of speed determination information 184 in which the width of the two-wheeled vehicle dedicated lane is associated with the target speed to be output by the subject vehicle M and the like. For example, it is assumed that the speed determination information 184 is stored in the storage 180 in advance.

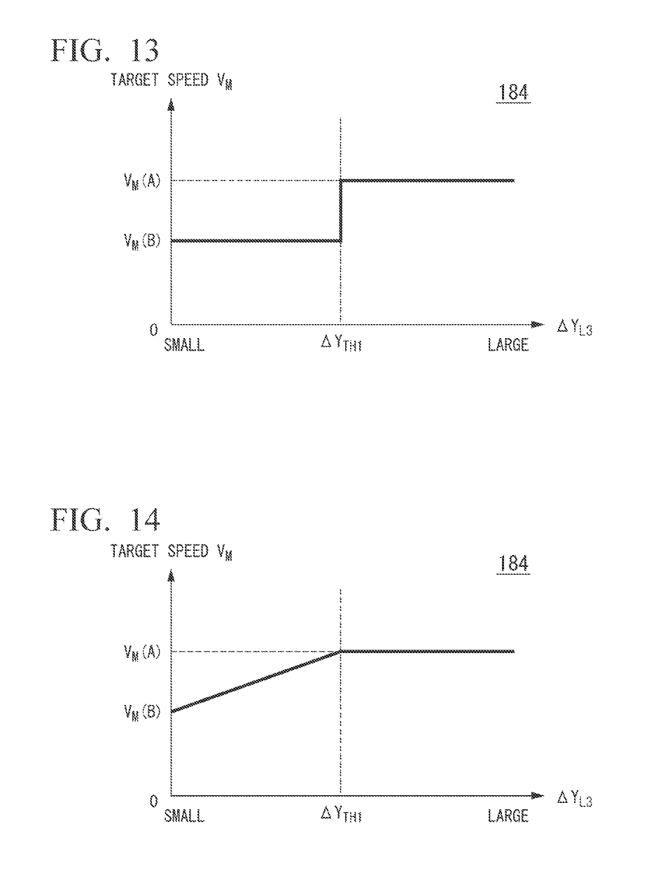

FIG. 13 is a diagram showing an example of the speed determination information 184. For example, the speed determination information 184 is information in which a target speed V_{M} to be output by the subject vehicle M is associated with the width ΔY_{L3} of the two-wheeled vehicle dedicated lane L3. For example, a first speed V_{M}(A) is associated with a width ΔY_{L3} that is a width ΔY_{L3} greater than a predetermined width ΔY_{TH1}, and a second speed V_{M}(B) less than the first speed V_{M}(A) is associated with a width ΔY_{L3} that is a width ΔY_{L3} equal to or less than the predetermined width ΔY_{TH1}. Therefore, in a case where the width ΔY_{L3} of the two-wheeled vehicle dedicated lane L3 is greater than the predetermined width ΔY_{TH1}, the target speed V_{M} of the subject vehicle M is determined as the relatively large first speed V_{M}(A), and in a case where the width ΔY_{L3} of the two-wheeled vehicle dedicated lane L3 is equal to or less than the predetermined width ΔY_{TH1}, the target speed V_{M} of the subject vehicle M is determined as the second speed V_{M}(B) less than the first speed V_{M}(A). Thus, in a case where the width ΔY_{L3} of the two-wheeled vehicle dedicated lane L3 is equal to or less than the predetermined width ΔY_{TH1}, the target trajectory generator 144 generates a target trajectory including the target speed V_{M} as the speed element less in comparison with a case where the width ΔY_{L3} of the two-wheeled vehicle dedicated lane L3 is greater than the predetermined width ΔY_{TH1}.

In the example described above, the target trajectory generator 144 determines the speed V_{M} of the subject vehicle M as one of two values of the first speed V_{M}(A) and the second speed V_{M}(B) based on the predetermined width ΔY_{TH1}, but the present invention is not limited thereto. For example, in a case where the width ΔY_{L3} of the two-wheeled vehicle dedicated lane L3 is equal to or less than the predetermined width ΔY_{TH1}, the target trajectory generator 144 may reduce the target speed V_{M} of the subject vehicle as the width ΔY_{L3} of the two-wheeled vehicle dedicated lane L3 becomes narrower.

FIG. 14 is a diagram showing another example of the speed determination information 184. For example, the speed determination information 184 may be information in which a smaller target speed V_{M} is associated with the width ΔY_{L3} of the two-wheeled vehicle dedicated lane L3 as the width ΔY_{L3} of the two-wheeled vehicle dedicated lane L3 becomes narrower, in a state in which an upper limit of the target speed V_{M} of the subject vehicle M is the first speed V_{M}(A) and a lower limit of the target speed V_{M} of the subject vehicle M is the second speed V_{M}(B). In the shown example, the target speed V_{M} is linearly changed according to the increase or decrease of the width ΔY_{L3} of the two-wheeled vehicle dedicated lane L3, but the present invention is not limited thereto, and the target speed V_{M} may be changed non-linearly such as a quadratic function or an exponential function. The speed determination information 184 is not limited to the information in which the target speed V_{M} is associated with the width ΔY_{L3} of the two-wheeled vehicle dedicated lane L3, but a target acceleration, a target jerk, a rate of change in speed, and the like may be associated with the width ΔY_{L3} of the two-wheeled vehicle dedicated lane L3.

As in the second embodiment, in a case where the two-wheeled vehicle dedicated lane is recognized and the two-wheeled vehicle OB is recognized in the two-wheeled vehicle dedicated lane by the recognizer 130, and further in a case where the maximum or the average of the variation amount of the lateral position of the two-wheeled vehicle OB is equal to or greater than a threshold value or the number of times greater than a threshold value is equal to or greater than a threshold value, the target trajectory generator 144 according to the fourth embodiment may generate a target trajectory including a smaller target speed V_{M} as the speed element, in comparison with a case where such an event does not occur.

As in the third embodiment, in a case where the two-wheeled vehicle dedicated lane is recognized and the two-wheeled vehicle OB is recognized in the two-wheeled vehicle dedicated lane by the recognizer 130, and further in a case where a part of the body of the two-wheeled vehicle OB that is present in the two-wheeled vehicle dedicated lane protrudes from the two-wheeled vehicle dedicated lane, the target trajectory generator 144 according to the fourth embodiment may generate a target trajectory including a smaller target speed V_{M} as the speed element, in comparison with a case where a part of the body of the two-wheeled vehicle OB that is present in the two-wheeled vehicle dedicated lane does not protrude from the two-wheeled vehicle dedicated lane.

According to the fourth embodiment described above, since in a case where the two-wheeled vehicle dedicated lane is not recognized and the two-wheeled vehicle OB is recognized by the recognizer 130, the target speed V_{M} of the subject vehicle M is caused to be smaller in comparison with a case where the two-wheeled vehicle dedicated lane is recognized and the two-wheeled vehicle OB is recognized in the two-wheeled vehicle dedicated lane by the recognizer 130, in a case where the two-wheeled vehicle dedicated lane is recognized and the two-wheeled vehicle OB is recognized in the two-wheeled vehicle dedicated lane by the recognizer 130, and further in a case where the variation amount of the lateral position of the two-wheeled vehicle OB is large, the target speed V_{M} of the subject vehicle M is caused to be small, or in a case where the two-wheeled vehicle dedicated lane is recognized and the two-wheeled vehicle OB is recognized in the two-wheeled vehicle dedicated lane by the recognizer 130, and further in a case where a part of the body of the two-wheeled vehicle OB that is present in the two-wheeled vehicle dedicated lane protrudes from the two-wheeled vehicle dedicated lane, the target speed V_{M} of the subject vehicle M is caused to be small, it is possible to cause the subject vehicle M to overtake the two-wheeled vehicle OB in a state in which the subject vehicle M is caused to be sufficiently far away from the two-wheeled vehicle of the adjacent lane and the speed of the subject vehicle M is sufficiently reduced.

[Hardware Constitution]

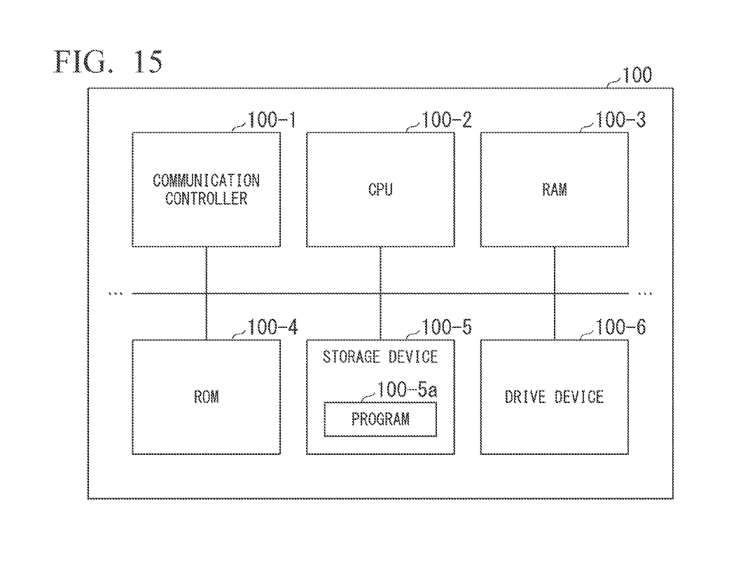

FIG. 15 is a diagram showing an example of a hardware constitution of the automated driving control device 100 according to an embodiment. As shown in the figure, the automated driving control device 100 includes a constitution in which a communication controller 100-1, a CPU 100-2, a RAM 100-3 used as a working memory, a ROM 100-4 storing a boot program and the like, a storage device 100-5 such as a flash memory or a HDD, a drive device 100-6 and the like are mutually connected by an internal bus or a dedicated communication line. The communication controller 100-1 communicates with components other than the automated driving control device 100. A program 100-5a executed by the CPU 100-2 is stored in the storage device 100-5. This program is developed in the RAM 100-3 by a direct memory access (DMA) controller (not shown) or the like and executed by the CPU 100-2. Therefore, a part or all of the first controller 120 and the second controller 160 are realized.

The above-described embodiment is able to be expressed as follows.

A vehicle control device, including:
a storage that stores a program; and

a processor,

wherein the processor executes the program to:

recognize a two-wheeled vehicle dedicated lane adjacent to a subject lane on which a subject vehicle is present and a two-wheeled vehicle that is present in front of the subject vehicle; and

control at least steering of the subject vehicle and cause the subject vehicle to move far away from the two-wheeled vehicle in a first case where the two-wheeled vehicle dedicated lane is not recognized and the two-wheeled vehicle is recognized, in comparison with a second case where the two-wheeled vehicle dedicated lane is recognized and the two-wheeled vehicle is recognized in the two-wheeled vehicle dedicated lane.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device, comprising:
a recognizer configured to recognize a two-wheeled vehicle dedicated lane adjacent to a subject lane on which a subject vehicle is present and a two-wheeled vehicle that is present in front of the subject vehicle; and
a driving controller configured to control at least steering of the subject vehicle and cause the subject vehicle to move far away from the two-wheeled vehicle in a first case where the two-wheeled vehicle dedicated lane is not recognized and the two-wheeled vehicle is recognized by the recognizer, in comparison with a second case where the two-wheeled vehicle dedicated lane is recognized and the two-wheeled vehicle is recognized in the two-wheeled vehicle dedicated lane by the recognizer.

2. The vehicle control device of claim 1,
wherein, in the first case, the driving controller causes the subject vehicle to move far away from the two-wheeled vehicle, and
in the second case, the driving controller causes the subject vehicle not to move far away from the two-wheeled vehicle.

3. The vehicle control device of claim 2,
wherein, in the second case, the driving controller further causes the subject vehicle to move far away from the two-wheeled vehicle, in a case where a width of the two-wheeled vehicle dedicated lane is equal to or less than a predetermined width.

4. The vehicle control device of claim 3,
wherein the driving controller causes the subject vehicle to move far away from the two-wheeled vehicle as the width of the two-wheeled vehicle dedicated lane, which is equal to or less than the predetermined width, becomes narrower.

5. The vehicle control device of claim 1,
wherein, in the second case, the driving controller further causes the subject vehicle to move far away from the two-wheeled vehicle based on a position related to a lane width direction of the two-wheeled vehicle recognized by the recognizer.

6. The vehicle control device of claim 1,
wherein, in the second case, the driving controller further causes the subject vehicle to move far away from the two-wheeled vehicle, in a case where a part of a body of the two-wheeled vehicle that is present in the two-wheeled vehicle dedicated lane is included in the subject lane.

7. The vehicle control device of claim 1,
wherein, in the first case, the driving controller further controls a speed of the subject vehicle to reduce the speed of the subject vehicle in comparison with the second case.

8. The vehicle control device of claim 7,
wherein, in the first case, the driving controller reduces the speed of the subject vehicle, and
in the second case, the driving controller does not reduce the speed of the subject vehicle.

9. The vehicle control device of claim 8,
wherein, in the second case, the driving controller further reduces the speed of the subject vehicle, in a case where a width of the two-wheeled vehicle dedicated lane is equal to or smaller than a predetermined width.

10. The vehicle control device of claim 9,
wherein the driving controller further reduces the speed of the subject vehicle as the width of the two-wheeled vehicle dedicated lane, which is equal to or less than the predetermined width, becomes narrower.

11. The vehicle control device of claim 7,
wherein, in the second case, the driving controller further reduces the speed of the subject vehicle based on a position related to a lane width direction of the two-wheeled vehicle recognized by the recognizer.

12. The vehicle control device of claim 7,
wherein, in the second case, the driving controller further reduces the speed of the subject vehicle in a case where a part of a body of the two-wheeled vehicle protrudes from the two-wheeled vehicle dedicated lane.

13. A vehicle control method that causes an in-vehicle computer to:
recognize a two-wheeled vehicle dedicated lane adjacent to a subject lane on which a subject vehicle is present and a two-wheeled vehicle that is present in front of the subject vehicle; and
control at least steering of the subject vehicle to cause the subject vehicle to move far away from the two-wheeled vehicle in a first case where the two-wheeled vehicle dedicated lane is not recognized and the two-wheeled vehicle is recognized, in comparison with a second case where the two-wheeled vehicle dedicated lane is recognized and the two-wheeled vehicle is recognized in the two-wheeled vehicle dedicated lane.

14. A computer-readable non-transitory storage medium storing a program that causes an in-vehicle computer to execute:
a process of recognizing a two-wheeled vehicle dedicated lane adjacent to a subject lane on which a subject vehicle is present and a two-wheeled vehicle that is present in front of the subject vehicle; and
a process of controlling at least steering of the subject vehicle to cause the subject vehicle to move far away from the two-wheeled vehicle in a first case where the two-wheeled vehicle dedicated lane is not recognized and the two-wheeled vehicle is recognized, in comparison with a second case where the two-wheeled vehicle dedicated lane is recognized and the two-wheeled vehicle is recognized in the two-wheeled vehicle dedicated lane.
